(19) United States
(12) Patent Application Publication
(10) Pub. No.: US 2026/0189085 A1
(43) Pub. Date: Jul. 2, 2026

(54) CONNECTION INTERFACES FOR ELECTRIC MOTORS

(71) Applicant: Donut Lab Development Oü, Harju maakond (EE)

(72) Inventors: Ville Piippo, Haarajoki (FI); Gareth Roberts, Swindon (GB); Joshua Best, Wiltshire (GB); Tero Ohranen, Tallinn (EE); Eetu-Kasper Heikkinen, Tallinn (EE); Nick Dowling, Bonshaw (CA); Harri Yli-Kujala, Helsinki (FI)

(21) Appl. No.: 19/274,796

(22) Filed: Jul. 21, 2025

Related U.S. Application Data
(60) Provisional application No. 63/741,163, filed on Jan. 2, 2025.

(51) Int. Cl. H02K 1/18

(52) U.S. Cl. CPC H02K 1/18

(57) ABSTRACT

Connection interfaces for electric motors are described. An example electric motor comprises a stator including an inner surface and a connection interface located along the inner surface. The connection interface includes a slot configured to slidingly receive a fitting of an interfacing component. The interfacing component is configured to be removably coupled to the stator at the connection interface. The electric motor further comprises a rotor circumscribing the stator. The rotor is configured to rotate relative to the stator.

### RELATED APPLICATIONS

This application claims priority to U.S. Provisional Ser. No. 63/741,163, filed Jan. 2, 2025. The entirety of U.S. Provisional Ser. No. 63/741,163 is hereby incorporated by reference herein.

### FIELD OF THE DISCLOSURE

This disclosure relates generally to electric motors and, more specifically, to connection interfaces for electric motors.

### BACKGROUND

Electric motors typically include a stator and a rotor, with the rotor being configured to rotate relative to the stator. The stator and the rotor can be implemented in either an inner rotor configuration in which the stator circumscribes the rotor, or conversely in an outer rotor configuration in which the rotor circumscribes the stator. The output of a rotor of an electric motor is typically transferred (e.g., via one or more operative coupling(s)) to another structure and/or device such that rotation of the rotor results in some form of movement (e.g., rotation, translation, etc.) of the structure and/or device. Electric motors are widely used across multiple industries (e.g., automotive, medical, household, etc.) and a variety of applications including vehicles, appliances, tools, fans, blowers, turbines, compressors, pumps, etc.

Electric vehicles have risen in popularity over the past decade. Electric vehicles are typically powered by one or more electric motor(s) that draw(s) electricity from an onboard rechargeable battery. Electric vehicles exist in many forms including, for example, wheeled electric vehicles configured for use and/or operation on land (e.g., cars, trucks, motorcycles, scooters, etc.), aerial electric vehicles configured for use and/or operation in the air (e.g., drones, helicopters, fixed-wing aircraft, etc.), and marine electric vehicles configured for use and/or operation in and/or under water (e.g., boats, submarines, etc.). In some implementations of a wheeled electric vehicle, the primary components of the electric motor are integrated into and/or incorporated within the wheel itself. Such implementations are commonly referred to as “in-wheel” electric motors.

For electric vehicles that incorporate one or more in-wheel electric motor(s), respective ones of the in-wheel electric motor(s) must be designed to connect to and/or interface with one or more system(s) of the electric vehicle. Such system(s) can include, for example, one or more suspension system(s), one or more steering system(s), one or more brake system(s), one or more electrical system(s), and/or one or more cooling system(s) of the electric vehicle. The development of parts and/or components that control how such system(s) ultimately interact with the in-wheel electric motor(s) can be slowed by dependencies on other events occurring during various phases of the development cycle. For example, precise part and/or component geometries impacting how a suspension system and/or a steering system interact(s) with an in-wheel electric motor of an electric vehicle to provide an overall “drive feel” for the electric vehicle are difficult to develop to their final state during the virtual phase of a development program for the electric vehicle. The development of such part and/or component geometries typically ends up being delayed until an electric vehicle is nearly ready to be released for production. As a result of such delays, the development of such part and/or component geometries often overlaps with one or more validation phase(s) of the development program for the electric vehicle. Efforts to reduce the resources needed to accelerate the development of such part and/or component geometries can reduce development risks associated with the development program for the electric vehicle as a whole, and would accordingly be of value to any manufacturer of an electric vehicle that incorporates one or more in-wheel electric motor(s).

### BRIEF DESCRIPTION OF THE DRAWINGS

FIG. 1 is a perspective view of an example electric motor including example connection interfaces.

FIG. 2 is a perspective view of the electric motor of FIG. 1 and a plurality of example interfacing components configured to be coupled to the connection interfaces of the electric motor.

FIG. 3 is a perspective view of the electric motor of FIGS. 1 and 2, with respective ones of the interfacing components of FIG. 2 shown coupled to corresponding ones of the connection interfaces of the electric motor.

FIG. 4 is a perspective view of a portion of the electric motor of FIGS. 1-3, with the first interfacing component of FIGS. 2 and 3 shown uncoupled from the first connection interface of the electric motor.

FIG. 5 is a perspective view of a portion of the electric motor of FIGS. 1-4, with the first interfacing component of FIG. 2-4 shown coupled to the first connection interface of the electric motor.

FIG. 6 is another perspective view of a portion of the electric motor of FIGS. 1-5, with the first interfacing component of FIGS. 2-5 shown coupled to the first connection interface of the electric motor.

FIG. 7 is a perspective view of a portion of the electric motor of FIGS. 1-6, with an example first interchangeable interfacing component shown coupled to the first connection interface of the electric motor.

FIG. 8 is a perspective view of a portion of the electric motor of FIGS. 1-7, with an example second interchangeable interfacing component shown coupled to the first connection interface of the electric motor.

FIG. 9 is a perspective view of another example connection interface and an example interfacing component configured to be coupled to the connection interface.

FIG. 10 is a perspective view of the connection interface of FIG. 9, with the interfacing component of FIG. 9 shown coupled to the connection interface.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Electric motors disclosed herein include at least one connection interface formed and/or otherwise located along an inner surface of the electric motor (e.g., along the inner surface of the stator of an outer rotor electric motor). Each connection interface is configured to enable an interfacing component to be removably coupled to the electric motor. In some disclosed examples, respective ones of a plurality of interfacing components include a fitting that is universally shaped and/or configured such that each one of the interfacing components can advantageously be removably coupled to the electric motor via the same connection interface of the electric motor. In some disclosed examples, the electric motor includes a plurality of connection interfaces. In some such disclosed examples, respective ones of the connection interfaces are universally shaped and/or configured such that any interfacing component including the above-described universally shaped and/or configured fitting can advantageously be removably coupled to the electric motor via different ones of the connection interfaces of the electric motor. Electric motors implementing the disclosed connection interfaces can accordingly be connected to various system-based geometries (e.g., suspension systems, steering systems, etc.) and/or other connections (e.g., brake systems, electrical systems, cooling systems, etc.) of an electric vehicle with limited changes to the structure of the electric motor itself in view of the interchangeable nature of the various interfacing components that are compatible with such connection interfaces.

Different connection interfaces can be implemented to facilitate different types of interfacing component connections that serve and/or support different performance features and/or different operational features associated with an electric motor. For example, various mechanical connection interfaces (e.g., suspension control arm mounting points, steering control arm mounting points, brake caliper mounting points, sway bar mounting points, radius rod mounting points, etc.) can be implemented to facilitate different types of mechanical interfacing component connections that serve and/or support different mechanical-based performance features and/or different mechanical-based operational features associated with an electric motor of an electric vehicle. As another example, various electrical connection interfaces (e.g., motor phase cable connection points, single sensor cable connection points, standard cable connectors, etc.) can be implemented to facilitate different types of electrical interfacing component connections that serve and/or support different electrical-based performance features and/or different electrical-based operational features associated with an electric motor of an electric vehicle. As yet another example, various cooling connection interfaces (e.g., bushings, adapters, etc., for pipes, hoses, etc. of a cooling system) can be implemented to facilitate different types of cooling interfacing component connections that serve and/or support different cooling-based performance features and/or different cooling-based operational features associated with an electric motor of an electric vehicle.

Electric motors implementing the disclosed connection interfaces provide numerous advantages, particularly with regard to promoting design and development efficiencies. For example, when a motor development entity utilizes an electric motor that includes the disclosed connection interfaces, design integration work to be performed by the motor development entity advantageously becomes less consuming and less costly due to the ability to focus and/or direct the design on one or more smaller and/or less complex component(s) (e.g., one or more interfacing component(s) that is/are compatible with the connection interfaces) rather than larger and/or more complex components that integrate all connections associated with the electric motor. As another example, the disclosed connection interfaces enable a motor development entity to advantageously incorporate and/or make use of more (e.g., a greater number) of off-the-shelf components, thereby limiting design, testing, and integration costs as well as lead time. The disclosed connection interfaces also enable a motor development entity to gain efficiencies with regard to economies of scale due to higher volumes in the off-the-shelf components offered to multiple customers or multiple end users across various manufactured vehicles. As another example, the disclosed connection interfaces enable a motor development entity to more easily outsource the development of application-specific components to a customer manufacturing entity. The disclosed connection interfaces also enable a motor development entity to commit to an almost ready (e.g., near final) design for the tooling of large scale parts earlier on in a project while leaving smaller interfacing components to be designed when the product (e.g., a vehicle) is further along in development advantageously compresses the total project timeline, reduces the risk of delays induced by unexpected findings in late stages of the overall project (e.g., a comprehensive vehicle program), and/or reduces (e.g., eliminates) validation phase waiting periods.

Electric motors implementing the disclosed connection interfaces also promote efficiencies with regard to managing vehicle lineups and related models. For example, developing product families with a large number of carryover components becomes easier when model-specific variances can be controlled and/or addressed via universally shaped and/or configured connection interfaces that are implemented in the electric motors of each member of the product family and/or each member of multiple product families. A larger number of shared component costs can accordingly be distributed across multiple related models (thereby benefiting from economies of scale), while a smaller number of tooling component costs are dedicated to individual ones of such related models.

Electric motors implementing the disclosed connection interfaces also promote serviceability efficiencies. For example, electric vehicles implementing one or more in-wheel electric motor(s) including the disclosed connection interfaces can advantageously reduce the costs and/or the service times that are associated with interfacing components that have required service intervals and/or that need to be replaced.

Electric motors implementing the disclosed connection interfaces also promote efficiencies for end users. For example, when an electric vehicle implements one or more in-wheel electric motor(s) including the disclosed connection interfaces, an end user has the ability to customize the electric vehicle with a replacement kit that contains one or more smaller components, rather than having to replace larger components. The end user can accordingly modify one or more feature(s) of the electric vehicle such as wheel size, and/or can fine tune the suspension and steering geometry associated with the electric vehicle, all at relatively lower costs than would otherwise be the case in the absence of the disclosed connection interfaces.

Electric motors implementing the disclosed connection interfaces can be used with and/or incorporated into many different types of vehicle-based applications. As one example, such electric motors can be used with and/or incorporated into a variety of land vehicles including but not limited to cars, vans, trucks, buses, motorcycles, mopeds, scooters, bicycles, trains, agricultural vehicles, construction vehicles, and tracked/treaded vehicles. As another example, such electric motors can be used with and/or incorporated into a variety of air vehicles including but not limited to airplanes, helicopters, and drones. As yet another example, such electric motors can be used with and/or incorporated into a variety of marine vehicles including but not limited to boats, ships, yachts, submarines, and jet skis.

Electric motors implementing the disclosed connection interfaces can also be used with and/or incorporated into many different types of applications that are not necessarily vehicle-based applications. For example, electric motors implementing the disclosed connection interfaces can be used with and/or incorporated into appliances, tools, fans, blowers, turbines, compressors, pumps, etc. used across multiple industries (e.g., medical, household, etc.). Example electric motors disclosed herein are configured as in-wheel electric motors for electric vehicles. An in-wheel electric motor is one form of a direct drive electric machine. The disclosed electric motors can alternatively be used in other industries and/or other direct drive electric machine applications that may or may not pertain to electric vehicles, and that may or may not include one or more wheel(s). While much of the description provided herein pertains to electric motors, the disclosed connection interfaces can alternatively by implemented by, on, and/or with other types of electric machines, including but not limited to electric generators.

The above-identified features as well as other advantageous features of example connection interfaces for electric motors are further described below in connection with the figures of the application.

As used herein, the term “electric machine(s)” encompasses electric motor(s) configured to transform electrical energy into mechanical energy, and further encompasses electric generator(s) configured to transform mechanical energy into electrical energy.

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

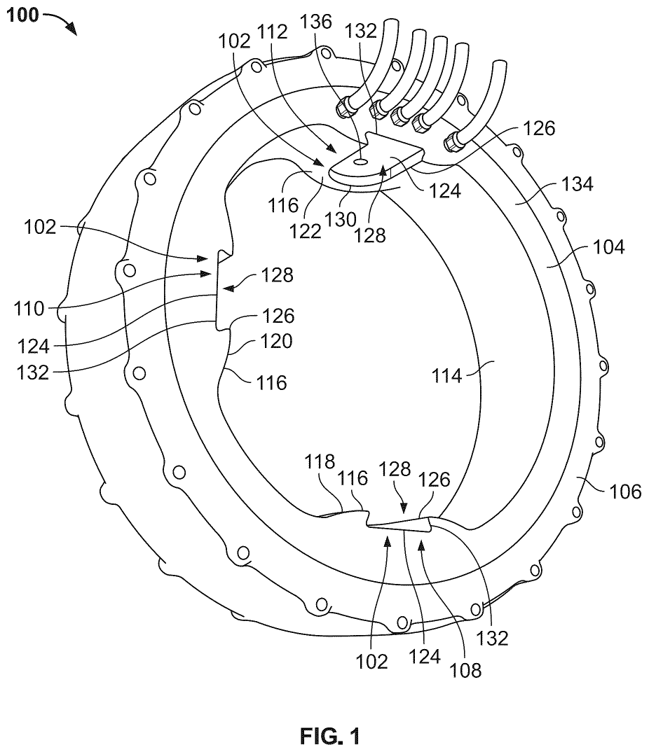

FIG. 1 is a perspective view of an example electric motor 100 including example connection interfaces 102. The electric motor 100 of FIG. 1 includes an example stator 104 and an example rotor 106. The rotor 106 of the electric motor 100 is configured to rotate relative to the stator 104 of the electric motor 100. In the illustrated example of FIG. 1, the electric motor 100 has an outer-rotor configuration in which the rotor 106 circumscribes the stator 104. In other examples, the electric motor 100 can instead have an inner-rotor configuration in which the stator 104 circumscribes the rotor 106. In the illustrated example of FIG. 1, the electric motor 100 includes a total of three individual ones of the connection interfaces 102, identified herein as an example first connection interface 108, an example second connection interface 110, and an example third connection interface 112. In other examples, the electric motor 100 can include a different number (e.g., 1, 2, 4, 6, 8, etc.) of the connection interfaces 102. In the illustrated example of FIG. 1, each one of the connection interfaces 102 (e.g., the first connection interface 108, the second connection interface 110, and the third connection interface 112) is structured and/or configured in an identical manner such that an interfacing component that is configured to be coupled to one of the connection interfaces 102 can interchangeably be coupled to any other one (e.g., all other ones) of the connection interfaces 102. In other examples, one or more of the connection interfaces 102 can instead be structured and/or configured in a manner that differs from the structure and/or configuration of one or more of the other ones of the connection interfaces 102.

Each one of the connection interfaces 102 (e.g., the first connection interface 108, the second connection interface 110, and the third connection interface 112) of the electric motor 100 of FIG. 1 is located along and/or formed in an example inner surface 114 of the stator 104 of the electric motor 100. In the illustrated example of FIG. 1, the inner surface 114 of the stator 104 includes example mounds 116 that extend radially inward relative to a surrounding local portion of the inner surface 114. For example, as shown in FIG. 1, the electric motor 100 includes a total of three individual ones of the mounds 116, identified herein as an example first mound 118, an example second mound 120, and an example third mound 122, with each one of the mounds 116 extending radially inward relative to a surrounding local portion of the inner surface 114 of the stator 104. Each one of the connection interfaces 102 is located and/or formed within (e.g., recessed within) a corresponding one of the mounds 116. For example, as shown in FIG. 1, the first connection interface 108 is located and/or formed within the first mound 118, the second connection interface 110 is located and/or formed within the second mound 120, and the third connection interface 112 is located and/or formed within the third mound 122. Each one of the mounds 116 has an aerodynamic shape and/or profile relative to the surrounding local portion of the inner surface 114 of the stator 104.

As shown in FIG. 1, respective ones of the mounds 116, and therefore also respective ones of the connection interfaces 102 located and/or formed therein, are circumferentially spaced apart from one another about the inner circumference defined by the inner surface 114 of the stator 104. In the illustrated example of FIG. 1, the third mound 122 is circumferentially spaced apart from the first mound 118 by approximately one hundred and eighty degrees (180°), and the second mound 120 is located between and circumferentially spaced apart from each of the first mound 118 and the third mound 122 by approximately ninety degrees (90°). Thus, as shown in FIG. 1, the third connection interface 112 is circumferentially spaced apart from the first connection interface 108 by approximately one hundred and eighty degrees (180°), and the second connection interface 110 is located between and circumferentially spaced apart from each of the first connection interface 108 and the third connection interface 112 by approximately ninety degrees (90°). In other examples, the relative circumferential spacing between the first mound 118, the second mound 120, and the third mound 122, and therefore also between the first connection interface 108, the second connection interface 110, and the third connection interface 112 can differ from the arrangement and/or configuration shown in FIG. 1.

In the illustrated example of FIG. 1, each one of the connection interfaces 102 has a dovetail configuration (e.g., a D-dovetail configuration) that includes an example base 124 and an example retention lip 126, with the retention lip 126 tapering inwardly relative to the base 124. Each dovetail configuration defined by the base 124 and the retention lip 126 of a corresponding one of the connection interfaces 102 forms an example slot 128 that is configured to slidingly receive (e.g., in an axial direction) an interfacing component that can be removably coupled to the corresponding one of the connection interfaces 102. In the illustrated example of FIG. 1, each slot 128 extends and/or is oriented in a direction that is substantially parallel to an axis of rotation of the electric motor 100 (e.g., the axis about which the rotor 106 of the electric motor 100 rotates). In other examples, each slot 128 can instead extend and/or be oriented in a direction that lies at an angle relative to the axis of rotation of the electric motor 100.

The slot 128 formed by the base 124 and the retention lip 126 of each one of the connection interfaces 102 has an example closed front end 130 and an example open rear end 132 located opposite the closed front end 130. The closed front end 130 is bounded by one or more surrounding portion(s) of the corresponding one of the mounds 116. The open rear end 132 is located along an example axial edge surface 134 of the stator 104. In the illustrated example of FIG. 1, the closed front end 130 of each slot 128 is curved, contoured, and/or rounded. In other examples, the closed front end 130 of the slot 128 can instead be linear, thereby resulting in a slot 128 that is generally rectangular in shape along the axial direction of the electric motor 100. The slot 128 formed by the base 124 and the retention lip 126 of a corresponding one of the connection interfaces 102 can have any shape and/or configuration that enables an interfacing component to be positioned and/or held within the slot 128, as further described herein.

An interfacing component (e.g., one of a plurality of interchangeable interfacing components) can be positioned within the slot 128 of a corresponding one of the connection interfaces 102 by sliding the interfacing component from the axial edge surface 134 of the stator 104 into the open rear end 132 of the slot 128 in an axial direction until the interfacing component reaches, abuts, and/or is adjacent to the closed front end 130 of the slot 128. When the interfacing component is positioned within the slot 128 of the corresponding one of the connection interfaces 102, the retention lip 126 of the corresponding one of the connection interfaces 102 prevents the interfacing component from becoming radially displaced from the slot 128. As further shown in FIG. 1, the base 124 of each one of the connection interfaces 102 includes an example opening 136 (e.g., a threaded opening) that extends depthwise in a radially outward direction from the base 124 and is configured to receive a fastener (e.g., a threaded bolt or a screw). When the interfacing component is positioned within the slot 128 of the corresponding one of the connection interfaces 102, a fastener that extends through the interfacing component and into the opening 136 of the corresponding one of the connection interfaces 102 prevents the interfacing component from becoming axially and/or radially displaced from the slot 128, as further described herein.

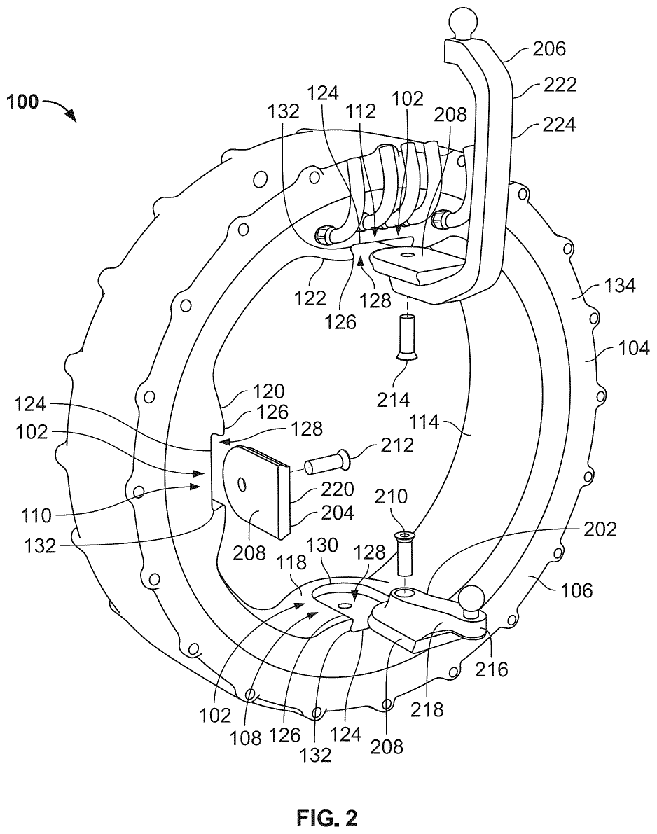

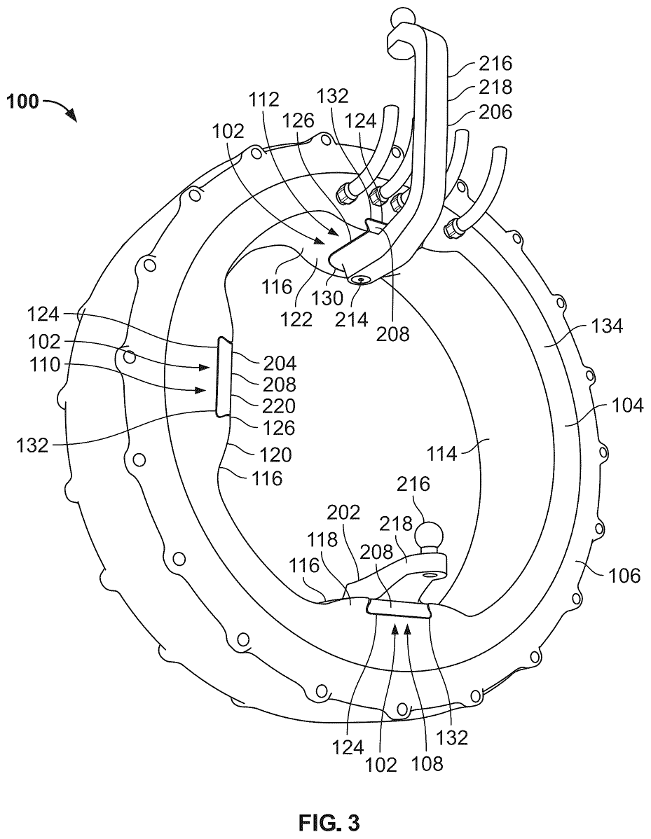

FIG. 2 is a perspective view of the electric motor 100 of FIG. 1 and a plurality of example interfacing components configured to be coupled to the connection interfaces 102 of the electric motor 100. FIG. 3 is a perspective view of the electric motor 100 of FIGS. 1 and 2, with respective ones of the interfacing components of FIG. 2 shown coupled to corresponding ones of the connection interfaces 102 of the electric motor 100. As shown in FIGS. 2 and 3, the interfacing components include an example first interfacing component 202 that is removably couplable to at least the first connection interface 108 of the electric motor 100, an example second interfacing component 204 that is removably couplable to at least the second connection interface 110 of the electric motor 100, and an example third interfacing component 206 that is removably couplable to at least the third connection interface 112 of the electric motor 100. In the illustrated example of FIGS. 2 and 3, the first interfacing component 202, the second interfacing component 204, and the third interfacing component 206 each include an example fitting 208 that is universally shaped and/or configured such that the first interfacing component 202, the second interfacing component 204, the third interfacing component 206, and/or any other interfacing component including such a universally shaped and/or configured fitting 208 can advantageously be removably coupled in an interchangeable manner to any one of the first connection interface 108, the second connection interface 110, and/or the third connection interface 112.

In the illustrated example of FIGS. 2 and 3, the fitting 208 of each one of the first interfacing component 202, the second interfacing component 204, and the third interfacing component 206 is configured to completely and/or fully fill, occupy, and/or complement the slot 128 of the corresponding one of the first connection interface 108, the second connection interface 110, and the third connection interface 112 of the electric motor 100 when coupled thereto. In other examples, the fitting 208 of the first interfacing component 202, the second interfacing component 204, and/or the third interfacing component 206 can instead be configured to only partially fill, occupy, and/or complement the slot 128 of the corresponding one of the first connection interface 108, the second connection interface 110, and/or the third connection interface 112 of the electric motor 100 when coupled thereto.

The first interfacing component 202 of FIGS. 2 and 3 is configured to become positioned within the slot 128 of the first connection interface 108 by sliding the fitting 208 of the first interfacing component 202 from the axial edge surface 134 of the stator 104 into the open rear end 132 of the slot 128 of the first connection interface 108 in an axial direction until the fitting 208 of the first interfacing component 202 reaches, abuts, and/or is adjacent to the closed front end 130 of the slot 128 of the first connection interface 108. When the fitting 208 of the first interfacing component 202 is positioned within the slot 128 of the first connection interface 108, the retention lip 126 of the first connection interface 108 prevents the fitting 208 of the first interfacing component 202 (and, more generally, the first interfacing component 202 as a whole) from becoming radially displaced from the slot 128. When the fitting 208 of the first interfacing component 202 is positioned within the slot 128 of the first connection interface 108, an example first fastener 210 (e.g., a threaded bolt or screw) that extends, in a radially outward direction, through the fitting 208 of the first interfacing component 202 into the opening 136 of the first connection interface 108 prevents the fitting 208 of first interfacing component 202 (and, more generally, the first interfacing component 202 as a whole) from becoming axially and/or radially displaced from the slot 128.

The second interfacing component 204 of FIGS. 2 and 3 is configured to become positioned within the slot 128 of the second connection interface 110 by sliding the fitting 208 of the second interfacing component 204 from the axial edge surface 134 of the stator 104 into the open rear end 132 of the slot 128 of the second connection interface 110 in an axial direction until the fitting 208 of the second interfacing component 204 reaches, abuts, and/or is adjacent to the closed front end 130 of the slot 128 of the second connection interface 110. When the fitting 208 of the second interfacing component 204 is positioned within the slot 128 of the second connection interface 110, the retention lip 126 of the second connection interface 110 prevents the fitting 208 of the second interfacing component 204 (and, more generally, the second interfacing component 204 as a whole) from becoming radially displaced from the slot 128. When the fitting 208 of the second interfacing component 204 is positioned within the slot 128 of the second connection interface 110, an example second fastener 212 (e.g., a threaded bolt or screw) that extends, in a radially outward direction, through the fitting 208 of the second interfacing component 204 into the opening 136 of the second connection interface 110 prevents the fitting 208 of second interfacing component 204 (and, more generally, the second interfacing component 204 as a whole) from becoming axially and/or radially displaced from the slot 128.

The third interfacing component 206 of FIGS. 2 and 3 is configured to become positioned within the slot 128 of the third connection interface 112 by sliding the fitting 208 of the third interfacing component 206 from the axial edge surface 134 of the stator 104 into the open rear end 132 of the slot 128 of the third connection interface 112 in an axial direction until the fitting 208 of the third interfacing component 206 reaches, abuts, and/or is adjacent to the closed front end 130 of the slot 128 of the third connection interface 112. When the fitting 208 of the third interfacing component 206 is positioned within the slot 128 of the third connection interface 112, the retention lip 126 of the third connection interface 112 prevents the fitting 208 of the third interfacing component 206 (and, more generally, the third interfacing component 206 as a whole) from becoming radially displaced from the slot 128. When the fitting 208 of the third interfacing component 206 is positioned within the slot 128 of the third connection interface 112, an example third fastener 214 (e.g., a threaded bolt or screw) that extends, in a radially outward direction, through the fitting 208 of the third interfacing component 206 into the opening 136 of the third connection interface 112 prevents the fitting 208 of third interfacing component 206 (and, more generally, the third interfacing component 206 as a whole) from becoming axially and/or radially displaced from the slot 128.

Although the first interfacing component 202, the second interfacing component 204, and the third interfacing component 206 shown in FIGS. 2 and 3 each include a universally shaped and/or configured version of the fitting 208, the overall structure and/or configuration of the respective ones of the first interfacing component 202, the second interfacing component 204, and the third interfacing component 206 otherwise differ from one another. For example, as shown in FIGS. 2 and 3, the first interfacing component 202 is implemented as a first example suspension component 216 having an example control arm 218 (e.g., culminating in a ball joint) that is coupled to (e.g., integrally formed with) the fitting 208 of the first interfacing component 202. The second interfacing component 204 is implemented as an example blank plate 220 that includes the fitting 208 with no additional mechanical structure coupled thereto. The third interfacing component 206 is implemented as a second example suspension component 222 having an example control arm 224 (e.g., culminating in a ball joint) that is coupled to (e.g., integrally formed with) the fitting 208 of the third interfacing component 206. As further shown in FIGS. 2 and 3, the control arm 218 of the first suspension component 216 extends in a radially inward direction (e.g., in addition to extending in an axial direction) relative to the stator 104 of the electric motor 100. By contrast, the control arm 224 of the second suspension component 222 extends briefly in a radially inward direction relative to the stator 104 of the electric motor 100 before changing course, with the control arm 224 of the second suspension component 222 ultimately extending in a radially outward direction (e.g., in addition to extending in an axial direction) relative to the stator 104 of the electric motor 100.

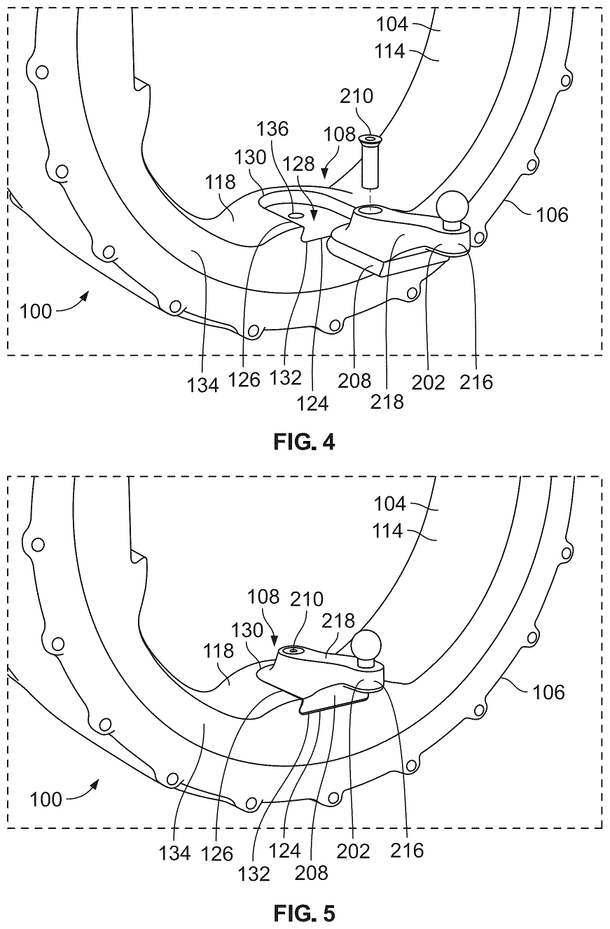

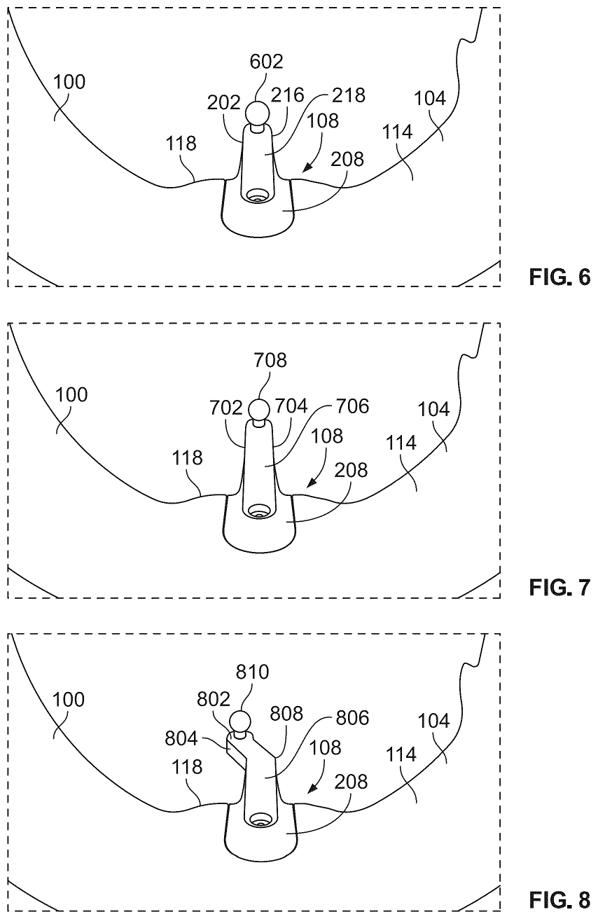

FIGS. 4-6 provide additional perspective views of a portion of the electric motor 100 of FIG. 1-3. More specifically, FIG. 4 is a perspective view of a portion of the electric motor 100 of FIGS. 1-3, with the first interfacing component 202 of FIGS. 2 and 3 shown uncoupled from the first connection interface 108 of the electric motor 100. FIG. 5 is a perspective view of a portion of the electric motor 100 of FIGS. 1-4, with the first interfacing component 202 of FIG. 2-4 shown coupled to the first connection interface 108 of the electric motor 100. FIG. 6 is another perspective view of a portion of the electric motor 100 of FIGS. 1-5, with the first interfacing component 202 of FIGS. 2-5 shown coupled to the first connection interface 108 of the electric motor 100.

As discussed above in connection with FIGS. 2 and 3 and further illustrated in FIGS. 4-6, the first interfacing component 202 is implemented as a first suspension component 216 having a control arm 218 that is coupled to (e.g., integrally formed with) the fitting 208 of the first suspension component 216, with the control arm 218 of the first suspension component 216 extending in a radially inward direction (e.g., in addition to extending in an axial direction) relative to the stator 104 of the electric motor 100. The control arm 218 of the first suspension component 216 shown in FIGS. 2-6 is linear, has an associated length, and has an associated angular orientation relative to the fitting 208 of the first suspension component 216 and/or relative to the axis of rotation of the electric motor 100. These configuration properties of the control arm 218 of the first suspension component 216 result in an example ball joint 602 of the first suspension component 216 being positioned at a specific location relative to a point of reference (e.g., a point along the axis of rotation of the electric motor 100). Variations and/or modified versions of the first interfacing component 202 having different dimensions, different shapes, and/or different angular orientations can advantageously be interchangeably coupled to the first connection interface 108 of the electric motor 100, and/or to other ones of the various connection interfaces 102 of the electric motor 100.

For example, FIG. 7 is a perspective view of a portion of the electric motor 100 of FIGS. 1-6, with an example first interchangeable interfacing component 702 shown coupled to the first connection interface 108 of the electric motor 100. The first interchangeable interfacing component 702 is implemented as a first interchangeable suspension component 704 having a control arm 706 that is coupled to (e.g., integrally formed with) the fitting 208 of the first interchangeable suspension component 704, with the control arm 706 of the first interchangeable suspension component 704 extending in a radially inward direction (e.g., in addition to extending in an axial direction) relative to the stator 104 of the electric motor 100. The control arm 706 of the first interchangeable suspension component 704 shown in FIG. 7 is linear, has an associated length, and has an associated angular orientation relative to the fitting 208 of the first interchangeable suspension component 704 and/or relative to the axis of rotation of the electric motor 100. The shape and the angular orientation of the control arm 706 of the first interchangeable suspension component 704 as shown in FIG. 7 generally match and/or are substantially identical to the corresponding shape and angular orientation of the control arm 218 of the first suspension component 216 as shown in FIG. 6. The length of the control arm 706 of the first interchangeable suspension component 704 as shown in FIG. 7, however, is greater than the corresponding length of the control arm 218 of the first suspension component 216 as shown in FIG. 6. As a result of this difference in length, an example ball joint 708 of the first interchangeable suspension component 704 shown in FIG. 7 is positioned at a specific location relative to a point of reference (e.g., a point along the axis of rotation of the electric motor 100) that differs from the specific location at which the ball joint 602 of the first suspension component 216 shown in FIG. 6 is positioned relative to the same point of reference.

As another example, FIG. 8 is a perspective view of a portion of the electric motor 100 of FIGS. 1-7, with an example second interchangeable interfacing component 802 shown coupled to the first connection interface 108 of the electric motor 100. The second interchangeable interfacing component 802 is implemented as a second interchangeable suspension component 804 having a control arm 806 that is coupled to (e.g., integrally formed with) the fitting 208 of the second interchangeable suspension component 804, with the control arm 806 of the second interchangeable suspension component 804 extending in a radially inward direction (e.g., in addition to extending in an axial direction) relative to the stator 104 of the electric motor 100. The control arm 806 of the second interchangeable suspension component 804 shown in FIG. 8 is nonlinear, has an associated length, and has an associated angular orientation relative to the fitting 208 of the second interchangeable suspension component 804 and/or relative to the axis of rotation of the electric motor 100. In view of an example bend 808 formed in the control arm 806 of the second interchangeable suspension component 804, the shape of the control arm 806 of the second interchangeable suspension component 804 as shown in FIG. 8 differs significantly from the corresponding shape of the control arm 218 of the first suspension component 216 as shown in FIG. 6 and/or from the corresponding shape of the control arm 706 of the first interchangeable suspension component 704 as shown in FIG. 7. As a result of this difference in shape, an example ball joint 810 of the second interchangeable suspension component 804 shown in FIG. 8 is positioned at a specific location relative to a point of reference (e.g., a point along the axis of rotation of the electric motor 100) that differs from the specific location at which the ball joint 602 of the first suspension component 216 shown in FIG. 6 is positioned relative to the same point of reference, and/or which differs from the specific location at which the ball joint 708 of the first interchangeable suspension component 704 shown in FIG. 7 is positioned relative to the same point of reference.

In some examples, the interchangeable nature of various interfacing components that are compatible with different ones of the connection interfaces 102 of the electric motor 100 of FIGS. 1-8 facilitates one or more suspension geometry adjustment(s) including but not limited to ride height, track width, wheelbase, camber angle, caster angle, toe angle, kingpin inclination, and wheel offset. For example, on a double wishbone suspension setup, a first suspension component (e.g., the first suspension component 216 described above) is removably coupled to the first connection interface 108 of the electric motor 100, and a second suspension component (e.g., the second suspension component 222 described above) is removably coupled to the third connection interface 112 of the electric motor 100. In such an example, the first and second suspension components can be replaced with corresponding first and second interchangeable suspension components configured to increase the track width of the suspension geometry without changing the wheel offset of the suspension geometry. Alternatively, the first and second suspension components can be replaced with corresponding first and second interchangeable suspension components configured to decrease the wheel offset of the suspension geometry without changing the track width of the suspension geometry. As another example, the first and second suspension components can be replaced with corresponding first and second interchangeable suspension components configured to increase the caster angle of the suspension geometry (e.g., by moving a ball joint associated with the first suspension component forward in association with the first interchangeable suspension component, and moving a ball joint associated with the second suspension component rearward in association with the second interchangeable suspension component). Alternatively, the first and second suspension components can be replaced with corresponding first and second interchangeable suspension components configured to decrease the caster angle of the suspension geometry (e.g., by moving a ball joint associated with the first suspension component rearward in association with the first interchangeable suspension component, and moving a ball joint associated with the second suspension component forward in association with the second interchangeable suspension component). Other kinematic variables that can be fine-tuned via the disclosed connection interfaces include but are not limited to suspension travel, roll center height, anti-dive and anti-squat behavior, bump steer geometry, and Ackermann steering angle specifics.

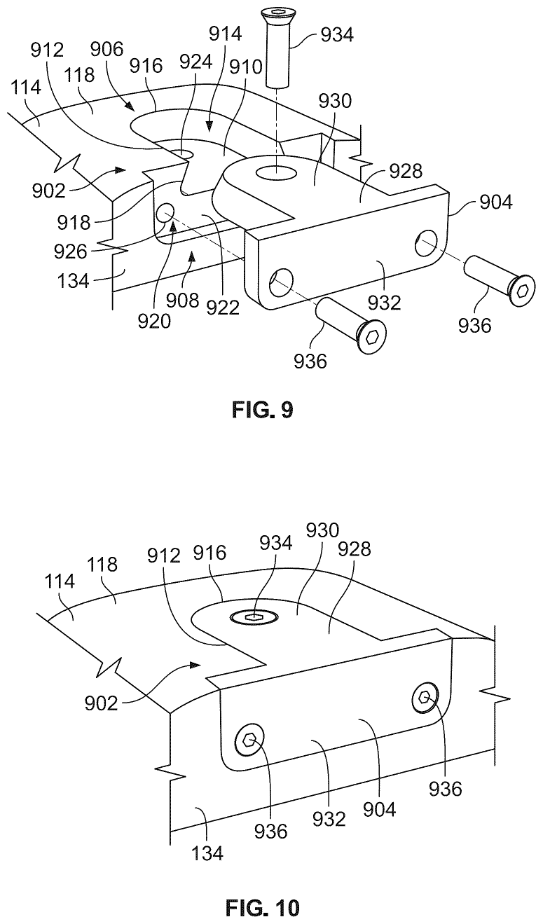

The electric motor of FIGS. 1-8 can be implemented with variations and/or modified versions of the connection interfaces 102 described above. For example, FIG. 9 is a perspective view of another example connection interface 902 and an example interfacing component 904 configured to be coupled to the connection interface 902. FIG. 10 is a perspective view of the connection interface 902 of FIG. 9, with the interfacing component 904 of FIG. 9 shown coupled to the connection interface 902. Like the first connection interface 108 of FIGS. 1-8 described above, the connection interface 902 of FIGS. 9 and 10 is located along and/or formed in the inner surface 114 of the stator 104 of the electric motor 100. More specifically, the connection interface 902 of FIGS. 9 and 10 is located and/or formed within the first mound 118 of the electric motor 100.

In the illustrated example of FIGS. 9 and 10, the connection interface 902 has a dovetail configuration (e.g., an LD-dovetail configuration) that includes an example slotted portion 906 and an example recessed portion 908. The slotted portion 906 of the connection interface 902 includes an example base 910 and an example retention lip 912, with the retention lip 912 tapering inwardly relative to the base 910. The slotted portion 906 defined by the base 910 and the retention lip 912 of the connection interface 902 forms an example slot 914 that is configured to slidingly receive (e.g., in an axial direction) the interfacing component 904, which can be removably coupled to the connection interface 902. In the illustrated example of FIGS. 9 and 10, the slot 914 extends and/or is oriented in a direction that is substantially parallel to an axis of rotation of the electric motor 100 (e.g., the axis about which the rotor 106 of the electric motor 100 rotates). In other examples, the slot 914 can instead extend and/or be oriented in a direction that lies at an angle relative to the axis of rotation of the electric motor 100.

The slot 914 formed by the base 910 and the retention lip 912 of the slotted portion 906 of the connection interface 902 has an example closed front end 916 and an example open rear end 918 located opposite the closed front end 916. The closed front end 916 of the slot 914 is bounded by one or more surrounding portion(s) of the first mound 118. The open rear end 918 of the slot 914 opens into an example recess 920 formed and/or defined by the recessed portion 908 of the connection interface 902, with the recess 920 being located along and/or formed into the axial edge surface 134 of the stator 104. In the illustrated example of FIGS. 9 and 10, the closed front end 916 of the slot 914 is curved, contoured, and or rounded. In other examples, the closed front end 916 of the slot 914 can instead be linear, thereby resulting in a slot 914 that is generally rectangular in shape along the axial direction of the electric motor 100. The slot 914 formed by the base 910 and the retention lip 912 of the slotted portion 906 of the connection interface 902 can have any shape and/or configuration that enables an interfacing component to be positioned and/or held within the slot 914, as further described herein. The recessed portion 908 of the connection interface 902 includes an example base 922 that partially defines the recess 920. In the illustrated example of FIGS. 9 and 10, the base 922 of the recessed portion 908 of the connection interface 902 is parallel to the axial edge surface 134 of the stator 104, and/or is perpendicular to the base 910 of the slotted portion 906 of the connection interface 902. In other examples, the base 922 of the recessed portion 908 of the connection interface 902 can be oriented at an angle relative to the axial edge surface 134 of the stator 104, and/or can be oriented at a non-perpendicular angle relative to the base 910 of the slotted portion 906 of the connection interface 902.

As further shown in FIGS. 9 and 10, the connection interface 902 includes at least one example first opening 924 (e.g., a threaded opening) formed in the base 910 of the slotted portion 906 of the connection interface 902, with each first opening 924 extending depthwise in a radially outward direction from the base 910 of the slotted portion 906 of the connection interface 902, and with each first opening 924 being configured to receive a corresponding first fastener (e.g., a threaded bolt or a screw). The connection interface 902 of FIGS. 9 and 10 further includes at least one example second opening 926 (e.g., a threaded opening) formed in the base 922 of the recessed portion 908 of the connection interface 902, with each second opening 926 extending depthwise in an axially inward direction from the base 922 of the recessed portion 908 of the connection interface 902, and with each second opening 926 being configured to receive a corresponding second fastener (e.g., a threaded bolt or a screw).

The interfacing component 904 of FIGS. 9 and 10 represents one of a plurality of interchangeable interfacing components that can be removably coupled to the connection interface 902. In the illustrated example of FIGS. 9 and 10, the interfacing component 904 includes an example fitting 928 that is universally shaped and/or configured such that the interfacing component 904 and any other interfacing component including such a universally shaped and/or configured fitting 928 can advantageously be removably coupled in an interchangeable manner to the connection interface 902, and/or to any other connection interface that is configured in a substantially identical manner as the connection interface 902. The interfacing component 904 is implemented as a blank filler that includes the fitting 928 with no additional mechanical structure coupled thereto. In other examples, various structural components (e.g., control arms of various configurations) can be coupled to (e.g., integrally formed with) the fitting 928 of the interfacing component 904.

In the illustrated example of FIGS. 9 and 10, the fitting 928 includes an example slot portion 930 that is configured to completely and/or fully fill, occupy, and/or complement the slot 914 of the slotted portion 906 of the connection interface 902 when the interfacing component 904 is coupled thereto, and an example recess portion 932 that is configured to completely and/or fully fill, occupy, and/or complement the recess 920 of the recessed portion 908 of the connection interface 902 when the interfacing component 904 is coupled thereto. In other examples, the slot portion 930 of the interfacing component 904 can instead be configured to only partially fill, occupy, and/or complement the slot 914 of the slotted portion 906 of the connection interface 902 when the interfacing component 904 is coupled thereto. Additionally, or alternatively, the recess portion 932 of the interfacing component 904 can instead be configured to only partially fill, occupy, and/or complement the recess 920 of the recessed portion 908 of the connection interface 902 when the interfacing component 904 is coupled thereto.

The interfacing component 904 of FIGS. 9 and 10 is configured to become positioned within the slot 914 and/or within the recess 920 of the connection interface 902 by sliding the slot portion 930 of the interfacing component 904 from the axial edge surface 134 of the stator 104 into the open rear end 918 of the slot 914 of the connection interface 902 in an axial direction until the slot portion 930 of the interfacing component 904 reaches, abuts, and/or is adjacent to the closed front end 916 of the slot 914 of the connection interface 902, and/or until the recess portion 932 of the interfacing component 904 reaches, abuts, and/or is adjacent to the base 922 of the recess 920 of the connection interface 902. When the slot portion 930 of the interfacing component 904 is positioned within the slot 914 of the connection interface 902, the retention lip 912 of the connection interface 902 prevents the slot portion 930 of the interfacing component 904 (and, more generally, the interfacing component 904 as a whole) from becoming radially displaced from the slot 914. When the slot portion 930 of the interfacing component 904 is positioned within the slot 914 of the connection interface 902, an example first fastener 934 (e.g., one or more threaded bolt(s) or screw(s) corresponding in number to the instances of the at least one first opening 924 described above) that extends, in a radially outward direction, through the slot portion 930 of the interfacing component 904 into the first opening 924 formed in the base 910 of the slotted portion 906 of the connection interface 902 prevents the slot portion 930 of interfacing component 904 (and, more generally, the interfacing component 904 as a whole) from becoming axially and/or radially displaced from the slot 914. Additionally, when the recess portion 932 of the interfacing component 904 is positioned within the recess 920 of the connection interface 902, an example second fastener 936 (e.g., one or more threaded bolt(s) or screw(s) corresponding in number to the instances of the at least one second opening 926 described above) that extends, in an axially inward direction, through the recess portion 932 of the interfacing component 904 into the second opening 926 formed in the base 922 of the recessed portion 908 of the connection interface 902 prevents the recess portion 932 of interfacing component 904 (and, more generally, the interfacing component 904 as a whole) from becoming axially and/or radially displaced from the recess 920.

The specific configuration, profile, and/or dimensions of each connection interface of the electric motor 100 can vary based on the use case of the electric motor 100, and may differ from the configurations, profiles, and/or dimensions shown and described in connection with FIGS. 1-10. For example, desired configuration and/or performance characteristics, attributes, features, and/or requirements may lead to the implementation of different configurations, profiles, and/or dimensions for respective ones of the connection interfaces of the electric motor 100. The specific configuration, profile, and/or dimensions of each connection interface can be selected in a manner that enables the connection interface to locate and/or to structurally support one or more interchangeable interfacing components on the electric motor 100.

In some examples, a connection interface of the electric motor 100 can include an I-dovetail configuration having a rectangular dovetail slot (e.g., formed by a base and a retention lip) located on the inner surface 114 of the electric motor 100, with the slot extending parallel to the axis of rotation of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) (e.g., one or more threaded opening(s)) formed in a base of the slot.

In some examples, a connection interface of the electric motor 100 can include a D-dovetail configuration having a rounded dovetail slot (e.g., formed by a base and a retention lip) located on the inner surface 114 of the electric motor 100, with the slot extending parallel to the axis of rotation of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) (e.g., one or more threaded opening(s)) formed in a base of the slot. The various connection interfaces 102 shown and described in connection with FIGS. 1-8 are representative examples of a connection interface having a D-Dovetail configuration.

In some examples, a connection interface of the electric motor 100 can include an L-dovetail configuration having a rectangular dovetail slot (e.g., formed by a base and a retention lip) located on the inner surface 114 of the electric motor 100, with the slot extending parallel to the axis of rotation of the electric motor 100, and further having a recess located along the axial edge surface 134 of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) (e.g., one or more threaded opening(s)) formed in a base of the slot, as well as via one or more fastener(s) (e.g., one or more threaded bolt(s) or screw(s)) that extend(s) in an axially inward direction (e.g., parallel to the axis of rotation of the electric motor 100) through one or more portion(s) of the interfacing component and into a corresponding one or more opening(s) (e.g., one or more threaded opening(s)) formed in a base of the recess.

In some examples, a connection interface of the electric motor 100 can include an LD-dovetail configuration having a rounded dovetail slot (e.g., formed by a base and a retention lip) located on the inner surface 114 of the electric motor 100, with the slot extending parallel to the axis of rotation of the electric motor 100, and further having a recess located along the axial edge surface 134 of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) (e.g., one or more threaded opening(s)) formed in a base of the slot, as well as via one or more fastener(s) (e.g., one or more threaded bolt(s) or screw(s)) that extend(s) in an axially inward direction (e.g., parallel to the axis of rotation of the electric motor 100) through one or more portion(s) of the interfacing component and into a corresponding one or more opening(s) (e.g., one or more threaded opening(s)) formed in a base of the recess. The connection interface 902 shown and described in connection with FIGS. 9 and 10 is a representative example of a connection interface having an LD-Dovetail configuration.

In some examples, a connection interface of the electric motor 100 can include a round configuration having a vertical, chamfered, and/or tapered surface for locating an interfacing component on the inner surface 114 of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) associated with the connection interface.

In some examples, a connection interface of the electric motor 100 can include a short thread configuration having a thread and/or bayonet attachment for locking an interfacing component on the inner surface 114 of the electric motor 100. In such examples, an interfacing component can be removably coupled to the connection interface of the electric motor 100 by turning the interfacing component within the locating feature for less than one full revolution. The interfacing component can be further coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) associated with the connection interface.

In some examples, a connection interface of the electric motor 100 can include a thread configuration having a thread (e.g., a short thread or a long thread) and/or bayonet attachment for locking an interfacing component on the inner surface 114 of the electric motor 100. In such examples, an interfacing component can be removably coupled to the connection interface of the electric motor 100 by turning the interfacing component within the locating feature for less than one full revolution. The interfacing component can be further coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) associated with the connection interface.

In some examples, a connection interface of the electric motor 100 can include an interlocking configuration having an interlocking feature for locking an interfacing component on the inner surface 114 of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) associated with the connection interface.

In some examples, a connection interface of the electric motor 100 can include a conical configuration having a conical surface for locking an interfacing component on the inner surface 114 of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) associated with the connection interface.

In some examples, a connection interface of the electric motor 100 can include a plate configuration having a plate for locking an interfacing component on the inner surface 114 of the electric motor 100. In such examples, an interfacing component can be removably coupled to the connection interface of the electric motor 100 via one or more fastener(s) (e.g., one or more threaded bolt(s) or screw(s)) that extend(s) in a radially outward direction (e.g., perpendicular to the axis of rotation of the electric motor 100) through one or more portion(s) of the interfacing component and into a corresponding one or more opening(s) associated with the connection interface.

In some examples, a connection interface of the electric motor 100 can include a sweeping configuration having a single or double curved surface for locking an interfacing component on the inner surface 114 of the electric motor 100. In such examples, an interfacing component can be removably coupled to the connection interface of the electric motor 100 via a moment that causes the interfacing component to flex in a manner that generates high contact area and friction.

The following paragraphs provide various examples in relation to the disclosed connection interfaces for electric motors.

Example 1 is an electric motor. In Example 1, the electric motor comprises a stator including an inner surface and a connection interface located along the inner surface. The connection interface includes a slot configured to slidingly receive a fitting of an interfacing component. The interfacing component is configured to be removably coupled to the stator at the connection interface. In Example 1, the electric motor further comprises a rotor circumscribing the stator. The rotor is configured to rotate relative to the stator.

Example 2 includes the electric motor of Example 1. In Example 2, the inner surface of the stator includes a mound extending radially inward relative to a surrounding local portion of the inner surface. The connection interface is formed in the mound.

Example 3 includes the electric motor of Example 2. In Example 3, the mound has an aerodynamic shape relative to the surrounding local portion of the inner surface.

Example 4 includes the electric motor of Example 2. In Example 4, the connection interface includes a base and a retention lip. The connection interface has a dovetail configuration defined by the base and the retention lip. The retention lip tapers inwardly relative to the base. The base and the retention lip collectively form the slot.

Example 5 includes the electric motor of Example 4. In Example 5, the base of the slot extends in a direction that is substantially parallel to an axis of rotation of the rotor.

Example 6 includes the electric motor of Example 4. In Example 6, the slot has a closed front end and an open rear end located opposite the closed front end.

Example 7 includes the electric motor of Example 6. In Example 7, the closed front end of the slot is bounded by one or more surrounding portions of the mound.

Example 8 includes the electric motor of Example 6. In Example 8, the closed front end of the slot is curved.

Example 9 includes the electric motor of Example 6. In Example 9, the open rear end of the slot is located along an axial edge surface of the stator.

Example 10 includes the electric motor of Example 9. In Example 10, the fitting of the interfacing component is configured to be positioned within the slot by sliding the fitting from the axial edge surface of the stator into the open rear end of the slot in an axial direction until the fitting abuts or is adjacent to the closed front end of the slot.

Example 11 includes the electric motor of Example 10 In Example 11, the retention lip of the of the connection interface prevents the fitting of the interfacing component from becoming radially displaced from the slot when the fitting is positioned within the slot.

Example 12 includes the electric motor of Example 11. In Example 12, the base of the connection interface includes a threaded opening extending depthwise in a radially outward direction from the base. The threaded opening is configured to receive a threaded fastener. The threaded fastener is configured to extend through the fitting of the interfacing component and into the threaded opening when the fitting is positioned within the slot. The threaded fastener prevents the fitting from becoming axially displaced from the slot when the fitting is positioned within the slot and the threaded fastener extends through the fitting and into the threaded opening.

Example 13 includes the electric motor of Example 1. In Example 13, the interfacing component is a suspension component including a control arm coupled to the fitting of the interfacing component.

Example 14 includes the electric motor of Example 13. In Example 14, the control arm extends in an axial direction and in a radially inward direction relative to the stator.

Example 15 includes the electric motor of Example 13. In Example 15, the control arm initially extends in a radially inward direction relative to the stator, then extends in an axial direction relative to the stator, and then extends in a radially outward direction relative to the stator.

Example 16 includes the electric motor of Example 1. In Example 16, the interfacing component is a blank plate including the fitting of the interfacing component with no additional mechanical structure coupled thereto.

Example 17 includes the electric motor of Example 1. In Example 17, the connection interface is a first connection interface. In Example 17, the stator further includes a second connection interface located along the inner surface. The second connection interface is circumferentially spaced apart from the first connection interface. The second connection interface includes a slot shaped substantially identical to the slot of the first connection interface. The fitting of the interfacing component is interchangeably removably couplable to the stator at respective ones the first connection interface and the second connection interface.

Example 18 includes the electric motor of Example 17. In Example 18, the second connection interface is located circumferentially opposite of the first connection interface.

Example 19 includes the electric motor of Example 18. In Example 19, the stator further includes a third connection interface located along the inner surface. The third connection interface is circumferentially spaced apart from and located circumferentially between the first connection interface and the second connection interface. The third connection interface includes a slot shaped substantially identical to the slot of the first connection interface and to the slot of the second connection interface. The fitting of the interfacing component is interchangeably removably couplable to the stator at respective ones the first connection interface, the second connection interface, and the third connection interface.

Example 20 includes the electric motor of Example 1. In Example 20, the connection interface is a first connection interface and the interfacing component is a first interfacing component. In Example 20, the stator further includes a second connection interface located along the inner surface. The second connection interface is circumferentially spaced apart from the first connection interface. The second connection interface includes a slot configured to slidingly receive a fitting of a second interfacing component. The second interfacing component is configured to be removably coupled to the stator at the second connection interface.

Example 21 includes the electric motor of Example 20. In Example 21, the slot of the second connection interface is shaped substantially identical to the slot of the first connection interface, and the fitting of the second interfacing component is shaped substantially identical to the fitting of the first interfacing component.

Example 22 includes the electric motor of Example 21. In Example 22, the second connection interface is located circumferentially opposite of the first connection interface.

Example 23 includes the electric motor of Example 22. In Example 23, the stator further includes a third connection interface located along the inner surface. The third connection interface is circumferentially spaced apart from and located circumferentially between the first connection interface and the second connection interface. The third connection interface includes a slot configured to slidingly receive a fitting of a third interfacing component. The third interfacing component is configured to be removably coupled to the stator at the third connection interface. The slot of the third connection interface is shaped substantially identical to the slot of the first connection interface and to the slot of the second connection interface, and the fitting of the third interfacing component is shaped substantially identical to the fitting of the first interfacing component and to the fitting of the second interfacing component.

Example 24 includes the electric motor of Example 23. In Example 24, an overall structure of the first interfacing component, an overall structure of the second interfacing component, and an overall structure of the third interfacing component differ from one another.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An electric motor, comprising:
a stator including:
an inner surface; and
a connection interface located along the inner surface, the connection interface including a slot configured to slidingly receive a fitting of an interfacing component, the interfacing component configured to be removably coupled to the stator at the connection interface; and
a rotor circumscribing the stator, the rotor configured to rotate relative to the stator.

2. The electric motor of claim 1, wherein the inner surface of the stator includes a mound extending radially inward relative to a surrounding local portion of the inner surface, wherein the connection interface is formed in the mound.

3. The electric motor of claim 2, wherein the mound has an aerodynamic shape relative to the surrounding local portion of the inner surface.

4. The electric motor of claim 2, wherein the connection interface includes a base and a retention lip, the connection interface having a dovetail configuration defined by the base and the retention lip, the retention lip tapering inwardly relative to the base, wherein the base and the retention lip collectively form the slot.

5. The electric motor of claim 4, wherein the base of the slot extends in a direction that is substantially parallel to an axis of rotation of the rotor.

6. The electric motor of claim 4, wherein the slot has a closed front end and an open rear end located opposite the closed front end.

7. The electric motor of claim 6, wherein the closed front end of the slot is bounded by one or more surrounding portions of the mound.

8. The electric motor of claim 6, wherein the closed front end of the slot is curved.

9. The electric motor of claim 6, wherein the open rear end of the slot is located along an axial edge surface of the stator.

10. The electric motor of claim 9, wherein the fitting of the interfacing component is configured to be positioned within the slot by sliding the fitting from the axial edge surface of the stator into the open rear end of the slot in an axial direction until the fitting abuts or is adjacent to the closed front end of the slot.

11. The electric motor of claim 10, wherein the retention lip of the of the connection interface prevents the fitting of the interfacing component from becoming radially displaced from the slot when the fitting is positioned within the slot.

12. The electric motor of claim 11, wherein the base of the connection interface includes a threaded opening extending depthwise in a radially outward direction from the base, the threaded opening configured to receive a threaded fastener, the threaded fastener configured to extend through the fitting of the interfacing component and into the threaded opening when the fitting is positioned within the slot, wherein the threaded fastener prevents the fitting from becoming axially displaced from the slot when the fitting is positioned within the slot and the threaded fastener extends through the fitting and into the threaded opening.

13. The electric motor of claim 1, wherein the interfacing component is a suspension component including a control arm coupled to the fitting of the interfacing component.

14. The electric motor of claim 13, wherein the control arm extends in an axial direction and in a radially inward direction relative to the stator.

15. The electric motor of claim 13, wherein the control arm initially extends in a radially inward direction relative to the stator, then extends in an axial direction relative to the stator, and then extends in a radially outward direction relative to the stator.

16. The electric motor of claim 1, wherein the interfacing component is a blank plate including the fitting of the interfacing component with no additional mechanical structure coupled thereto.

17. The electric motor of claim 1, wherein the connection interface is a first connection interface, wherein the stator further includes a second connection interface located along the inner surface, the second connection interface circumferentially spaced apart from the first connection interface, the second connection interface including a slot shaped substantially identical to the slot of the first connection interface, wherein the fitting of the interfacing component is interchangeably removably couplable to the stator at respective ones the first connection interface and the second connection interface.

18. The electric motor of claim 17, wherein the second connection interface is located circumferentially opposite of the first connection interface.

19. The electric motor of claim 18, wherein the stator further includes a third connection interface located along the inner surface, the third connection interface circumferentially spaced apart from and located circumferentially between the first connection interface and the second connection interface, the third connection interface including a slot shaped substantially identical to the slot of the first connection interface and to the slot of the second connection interface, wherein the fitting of the interfacing component is interchangeably removably couplable to the stator at respective ones the first connection interface, the second connection interface, and the third connection interface.

20. The electric motor of claim 1, wherein the connection interface is a first connection interface and the interfacing component is a first interfacing component, wherein the stator further includes a second connection interface located along the inner surface, the second connection interface circumferentially spaced apart from the first connection interface, the second connection interface including a slot configured to slidingly receive a fitting of a second interfacing component, the second interfacing component configured to be removably coupled to the stator at the second connection interface.

21. The electric motor of claim 20, wherein the slot of the second connection interface is shaped substantially identical to the slot of the first connection interface, wherein the fitting of the second interfacing component is shaped substantially identical to the fitting of the first interfacing component.

22. The electric motor of claim 21, wherein the second connection interface is located circumferentially opposite of the first connection interface.

23. The electric motor of claim 22, wherein the stator further includes a third connection interface located along the inner surface, the third connection interface circumferentially spaced apart from and located circumferentially between the first connection interface and the second connection interface, the third connection interface including a slot configured to slidingly receive a fitting of a third interfacing component, the third interfacing component configured to be removably coupled to the stator at the third connection interface, wherein the slot of the third connection interface is shaped substantially identical to the slot of the first connection interface and to the slot of the second connection interface, wherein the fitting of the third interfacing component is shaped substantially identical to the fitting of the first interfacing component and to the fitting of the second interfacing component.

24. The electric motor of claim 23, wherein an overall structure of the first interfacing component, an overall structure of the second interfacing component, and an overall structure of the third interfacing component differ from one another.
